(19) United States
(12) Patent Application Publication
(10) Pub. No.: US 2020/0068648 A1
(43) Pub. Date: Feb. 27, 2020

(54) METHOD AND APPARATUS FOR DISCONTINUOUS RECEPTION

(71) Applicant: GUANGDONG OPPO MOBILE TELECOMMUNICATIONS CORP., LTD., Dongguan, Guangdong (CN)

(72) Inventor: Yanan LIN, Dongguan, Guangdong (CN)

(21) Appl. No.: 16/467,327

(22) PCT Filed: Dec. 13, 2016
(86) PCT No.: PCT/CN2016/109719

§ 371 Date: Jun. 6, 2019

(51) Int. Cl. H04W 76/28; H04W 52/02; H04W 72/04; H04W 76/27

(52) U.S. Cl. CPC H04W 76/28; H04W 52/0216; H04W 76/27; H04W 72/042; H04W 52/0229

(57) ABSTRACT

A method for discontinuous reception includes: receiving, by a terminal, switch indication information sent by a network device and used to instruct the terminal to switch from a first discontinuous reception DRX pattern being used to a second DRX pattern, wherein each of the first DRX pattern and the second DRX pattern indicates a duration of a DRX sleeping period and a duration of a DRX active period; and switching, by the terminal, between the DRX sleeping period and the DRX active period with the second DRX pattern based on the switch indication information.

### CROSS-REFERENCE TO RELATED APPLICATIONS

This application is a U.S. national phase application of International Application No. PCT/CN2016/109719, filed Dec. 13, 2016, the entire disclosure of which is incorporated herein by reference.

### TECHNICAL FIELD

Embodiments of the present invention relates to the field of communication, and more particularly, to a method and an apparatus for discontinuous reception.

### BACKGROUND

The transmission of packet-based data streams usually bursts. It is possible that data is transmitted between a network device and a terminal during a time period, but no data will be transmitted during a next long time period. During the period when no data is transmitted, the terminal may reduce its power consumption by stopping receiving the Physical Downlink Control Channel (PDCCH), thereby improving usage time of the terminal's battery. The communication method between the terminal and the network device as described in the above is discontinuous reception (DRX).

However, this periodic DRX working mechanism in the prior art makes the time period when the terminal is in an active mode and the time period when the terminal is in a sleeping mode relatively fixed, which reduces the flexibility of the terminal in communicating with the network device using the DRX working mechanism.

### SUMMARY

There are provided a method and apparatus for discontinuous reception in embodiments of the present invention.

In a first aspect, there is provided a method for discontinuous reception, comprising: receiving, by a terminal, switch indication information sent by a network device and used to instruct the terminal to switch from a first discontinuous reception DRX pattern currently being used to a second DRX pattern, wherein each of the first DRX pattern and the second DRX pattern indicates a duration of a DRX sleeping period and a duration of a DRX active period; and switching, by the terminal, between the DRX sleeping period and the DRX active period with the second DRX pattern based on the switch indication information.

In a second aspect, there is provided a method for discontinuous reception, comprising: sending, by a network device, switch indication information to a terminal, which is used to instruct the terminal to switch from a first discontinuous reception DRX pattern currently being used to a second DRX pattern, wherein the first DRX pattern and the second DRX pattern indicate a duration of a DRX sleeping period and a duration of a DRX active period; sending, by the network device, downlink data to the terminal when the terminal is in the duration of the DRX active period with the second DRX pattern.

In a third aspect, there is provided an apparatus for discontinuous reception, comprising modules for performing the methods in the first aspect.

In a fourth aspect, there is provided an apparatus for discontinuous reception, comprising modules for performing the methods in the second aspect.

In a fifth aspect, there is provided an apparatus for discontinuous reception, comprising a memory, a processor and a transceiver, wherein the memory is used for storing instructions, and the processor is used for performing instructions, and wherein when the instructions are performed, the processor performs methods in the first aspect based on the transceiver.

In a sixth aspect, there is provided an apparatus for discontinuous reception, comprising a memory, a processor and a transceiver; wherein the memory is used for storing instructions, and the processor is used for performing instructions, and wherein when the instructions are performed, the processor performs methods in the second aspect based on the transceiver.

In a seventh aspect, there is provided a computer-readable medium, wherein the computer-readable medium is used for storing a program code to be performed, wherein the program code comprises instructions for performing methods in the first aspect.

In an eighth aspect, there is provided a computer-readable medium, wherein the computer-readable medium is used for storing a program code for performance, wherein the program code comprises instructions for performing methods in the second aspect.

### BRIEF DESCRIPTION OF THE DRAWINGS

FIG. 1 illustrates a radio communication system 100 to which embodiments of the present invention are applied.

FIG. 2 is a flow chart of a method for discontinuous reception according to an embodiment of the present invention.

FIG. 3 is a schematic diagram of a DRX pattern according to an embodiment of the present invention.

FIG. 4 is a flow chart of a method for discontinuous reception according to another embodiment of the present invention.

FIG. 5 is a block diagram of an apparatus for discontinuous reception according to an embodiment of the present invention.

FIG. 6 is a block diagram of an apparatus for discontinuous reception according to another embodiment of the present invention.

FIG. 7 is a block diagram of a terminal for discontinuous reception according to an embodiment of the present invention.

FIG. 8 is a block diagram of a network device for discontinuous reception according to an embodiment of the present invention.

### DETAILED DESCRIPTION

The description of the technical solution in exemplary embodiments of the present invention will be made with reference to the drawings in the following.

FIG. 1 illustrates a radio communication system 100 to which embodiments of the present invention is applied. The radio communication system 100 may include a network device 110. The network device 110 may be a device that communicates with a terminal device. The network device 110 may provide communication coverage for a particular geographic area and may communicate with terminal devices located within the coverage area.

FIG. 1 exemplarily illustrates a network device and two terminals. Optionally, the radio communication system 100 may include a plurality of network devices and may include other numbers of terminals within the coverage of each network device. This is not specifically restricted in embodiments of the present invention.

Optionally, the radio communication system 100 may also include other network entities such as a network controller, a mobility management entity and so on. This is not specifically restricted in embodiments of the present invention.

It should be understood that the technical solution of the present invention may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced Long Term Evolution (LTE-A) system, a Universal Mobile Telecommunication System (UMTS), a NR (New Radio Access Technology), 5G or the like.

It should also be understood that, in embodiments of the present invention, the terminal device may include but is not limited to a Mobile Station (MS), a Mobile Terminal, a Mobile Telephone, a User Equipment (UE), a handset, a portable equipment and so on. The terminal device may communicate with one or more core networks via a Radio Access Network (RAN). For example, the terminal device may be a mobile phone (or also called as a “cellular” phone), a computer with a radio communication function and so on. The terminal device may also be a mobile device which is portable, pocket-sized, handheld, computer-integrated or on-board.

In embodiments of the present invention, a network device may be an access network device, such as a base station, a Transmitting and Receiving Point (TRP) or an access point. The base station may be a Base Transceiver Station (BTS) of GSM or CDMA, and may also be a NodeB of WCDMA, an evolved Node B (eNB or e-NodeB) of LTE, or a gNB of NR or 5G. This is not specifically restricted in embodiments of the present invention.

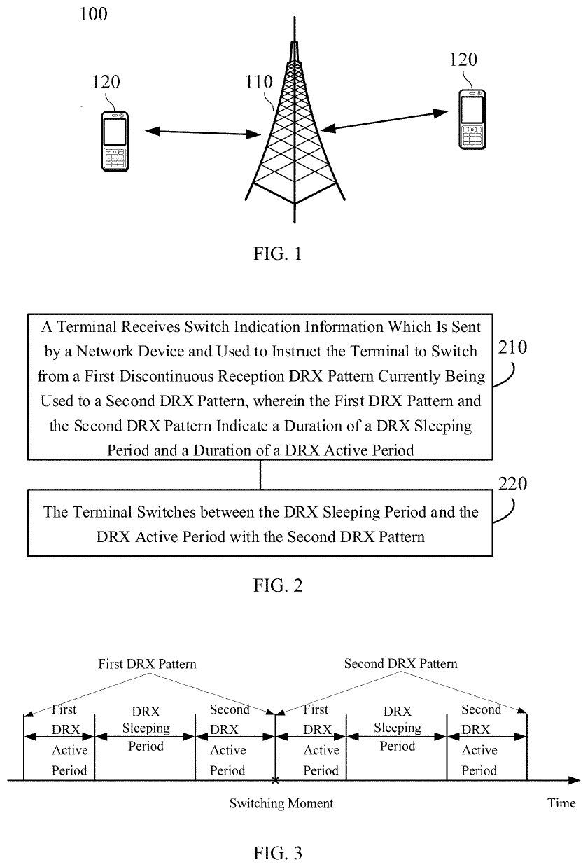

FIG. 2 is a flow chart of a method for discontinuous reception according to an embodiment of the present invention. The method as illustrated in FIG. 2 includes the following steps.

At 210, a terminal receives switch indication information which is sent by a network device and used to instruct the terminal to switch from a first discontinuous reception DRX pattern currently being used to a second DRX pattern, wherein the first DRX pattern and the second DRX pattern indicate a duration of a DRX sleeping period and a duration of a DRX active period.

It should be noted that the first DRX pattern and/or the second DRX pattern may be a DRX pattern pre-configured for the terminal by the network device or a default DRX pattern under protocols. It may also be a DRX pattern which is instructed to the terminal by the network device. This is not specifically restricted in embodiments of the present invention.

Optionally, the first DRX pattern and the second DRX pattern may also indicate the duration of the DRX sleeping period and the duration of the DRX active period during the first DRX active period to the terminal.

Optionally, the terminal takes the start time of the DRX transmission with the first DRX pattern as the sending time at which the terminal sends uplink data.

Specifically, the DRX transmission by the terminal with the first DRX pattern is triggered by the terminal sending uplink data.

Specifically, the first DRX active period may be the DRX active period during which the terminal performs DRX transmission periodically with technologies in the prior art. That is, when the terminal is in the DRX active period in a manner of combining a timer with a DRX period using technologies in the prior art, the terminal may switch between the DRX sleeping period and the DRX active period with the DRX patterns, so that the terminal switches between the DRX sleeping period and the DRX active period during the first DRX active period so as to further reduce the power consumption.

At 220, the terminal switches between the DRX sleeping period and the DRX active period with the second DRX pattern.

For example, FIG. 3 is a schematic diagram of a DRX pattern according to an embodiment of the present invention. It can be seen from the DRX transmission mechanism shown in FIG. 3 that the terminal performs DRX transmission with the first DRX pattern, the terminal switches from the first DRX pattern to the second DRX pattern at a switching moment, and the terminal performs DRX transmission with the second DRX pattern after the switching moment.

It should be understood that the switching moment may be a moment when the terminal receives the switch indication information sent by the network device, or may be a moment when a preset time period after the moment when the terminal receives the switch indication information sent by the network device ends. This is not specifically restricted in embodiments of the present invention.

It should be noted that the first DRX pattern includes a first DRX active period, a DRX sleeping period and a second DRX active period. The duration of the first DRX active period included in the first DRX pattern, the duration of the DRX sleeping period included in the first DRX pattern, and the duration of the second DRX active period included in the first DRX pattern may be either the same or different. Similarly, the second DRX pattern also includes a first DRX active period, a DRX sleeping period and a second DRX active period. The duration of the first DRX active period included in the second DRX pattern, the duration of the DRX sleeping period included in the second DRX pattern, and the duration of the second DRX active period included in the second DRX pattern may be either the same or different. This is not specifically restricted in embodiments of the present invention.

Optionally, as an embodiment, the method further comprises: receiving, by the terminal, first indication information sent by the network device, which indicates the second DRX pattern.

Optionally, as an embodiment, the method further comprises: determining, by the terminal, the second DRX pattern from a DRX pattern set based on the first indication information, wherein the DRX pattern set includes a plurality of different DRX patterns.

Optionally, as an embodiment, the method further comprises: receiving, by the terminal, configuration information sent by the network device, wherein the configuration information is used to configure the DRX pattern set for the terminal.

Specifically, the terminal receives configuration information sent by the network device, wherein the configuration information indicates a DRX pattern set configured for the terminal by the network device and including a plurality of DRX patterns. Optionally, sending the first indication information to the terminal by the network device may refer to sending an ID of the DRX pattern to the terminal by the network device. The terminal may choose a DRX pattern from the DRX pattern set based on the ID of the DRX pattern.

Optionally, as an embodiment, the method further comprises: receiving, by the terminal, second indication information sent by the network device and indicating a time period during which the second DRX pattern is used. Switching, by the terminal, between the DRX sleeping period and the DRX active period with the second DRX pattern comprises: switching, by the terminal, between the DRX sleeping period and the DRX active period with the second DRX pattern during the time period.

Specifically, the time period of the second DRX pattern may refer to the time period during which the terminal switches between the DRX sleeping period and the DRX active period with the second DRX pattern.

It should be noted that, after the time period, the terminal switches between the DRX sleeping period and the DRX active period with the first DRX pattern. Alternatively, the terminal may perform the DRX communication in a manner of combining a timer with the DRX period using technologies in the prior art in the DRX terminal after the time period. This is not specifically restricted in embodiments of the present invention.

Optionally, as an embodiment, the method further comprises: switching, by the terminal, between the DRX sleeping period and the DRX active period with the first DRX pattern after the time period.

Specifically, the first DRX pattern may be a DRX pattern preconfigured by the network device for the terminal, a default DRX pattern under protocols, or a DRX pattern which is instructed to the terminal by the network device. This is not specifically restricted in embodiments of the present invention.

Optionally, as an embodiment, the method further comprises: switching, by the terminal, between the DRX sleeping period and the DRX active period with the second DRX pattern after the time period.

Optionally, as an embodiment, the method further comprises: receiving, by the terminal, third indication information which is sent by the network device and used to instruct the terminal to stop switching between the DRX sleeping period and the DRX active period with the second DRX pattern; stopping, by the terminal, switching between the DRX sleeping period and the DRX active period with the second DRX pattern.

It should be noted that, the terminal may switch between the DRX sleeping period and the DRX active period with the first DRX pattern after the terminal receives the third indication information sent by the network device, and the terminal may also perform DRX communication in a manner of combining a timer with the DRX period using technologies in the prior art in the DRX terminal after the time period. This is not specifically restricted in embodiments of the present invention.

Optionally, as an embodiment, the method further comprises: switching, by the terminal, between the DRX sleeping period and the DRX active period with the first DRX pattern.

Optionally, as an embodiment, the method further comprises: receiving, by the terminal, fourth indication information which is sent by the network device and indicates at least one of the following: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following: service quality or a service attribute corresponding to downlink data to be transmitted; time required for encoding uplink and/or downlink data; time required for decoding uplink and/or downlink data; transmission time required for transmitting uplink data and/or downlink data.

Specifically, the duration of the DRX sleeping period and/or the duration of the DRX active period as indicated by the DRX pattern (including the first DRX pattern and/or the second DRX pattern) are determined based on at least one of the following: service quality or a service attribute corresponding to downlink data to be transmitted; time required for encoding uplink and/or downlink data; time required for decoding uplink and/or downlink data; transmission time required for transmitting uplink data and/or downlink data.

The service quality corresponding to downlink data to be transmitted comprises a delay requirement of transmitting downlink data to be transmitted and the like. The service attribute corresponding to downlink data to be transmitted comprises a time interval of transmitting downlink data to be transmitted and the like.

Optionally, as an embodiment, receiving, by a terminal, switch indication information sent by a network device comprises: receiving, by the terminal, downlink data carrying the switch indication information sent by the network device.

Specifically, the downlink data may be service data or data of a downlink control channel. When the downlink data are service data, the service data may be any one of the following: downlink data transmitted in a Protocol Data Unit (PDU) of Media Access Control (MAC) layer, downlink data transmitted in a Protocol Data Unit (PDU) of Radio Link Control (RLC) layer, and downlink data transmitted in a Protocol Data Unit (PDU) of Packet Data Convergence Protocol (PDCP) layer.

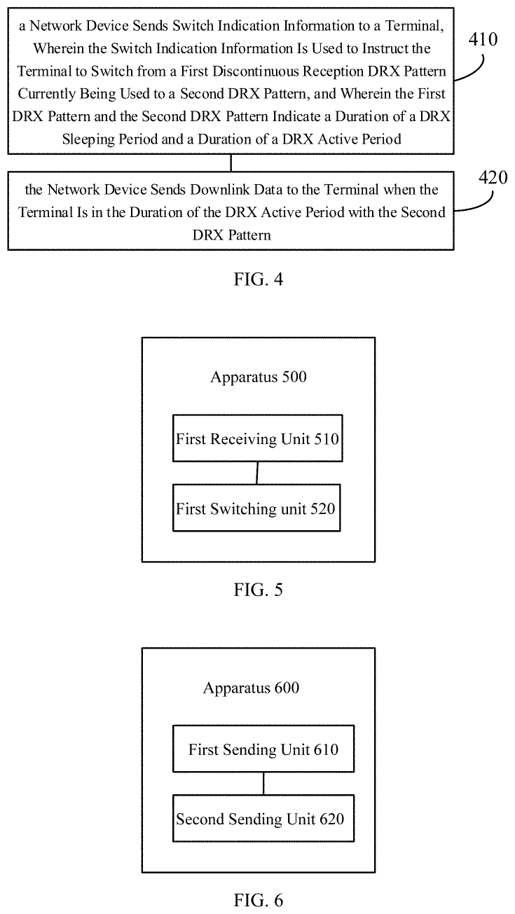

FIG. 4 is a flow chart of a method for discontinuous reception according to another embodiment of the present invention. The method as illustrated in FIG. 4 includes the following steps.

At 410, a network device sends switch indication information to a terminal, wherein the switch indication information is used to instruct the terminal to switch from a first discontinuous reception DRX pattern currently being used to a second DRX pattern, and wherein the first DRX pattern and the second DRX pattern indicate a duration of a DRX sleeping period and a duration of a DRX active period.

At 420, the network device sends downlink data to the terminal when the terminal is in the duration of the DRX active period with the second DRX pattern.

Optionally, as an embodiment, the method further comprises: sending, by the network device, first indication information indicating the second DRX pattern to the terminal.

Optionally, as an embodiment, the method further comprises: sending, by the network device, second indication information to the terminal, wherein the second indication information indicates a time period during which the terminal uses the second DRX pattern.

Optionally, as an embodiment, the method further comprises: sending, by the network device, third indication information to the terminal, which is used to instruct the terminal to stop switching between the DRX sleeping period and the DRX active period with the second DRX pattern.

Optionally, as an embodiment, the method further comprises: sending, by the network device, fourth indication information indicating at least one of the following to the terminal: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following: service quality or a service attribute corresponding to downlink data to be transmitted; time required for encoding uplink and/or downlink data; time required for decoding uplink and/or downlink data; transmission time required for transmitting uplink data and/or downlink data.

Optionally, as an embodiment, sending, by a network device, switch indication information to a terminal comprises: sending, by the network device, the downlink data carrying the switch indication information to the terminal.

Optionally, as an embodiment, the downlink data may be any one of the following: downlink data transmitted in a Protocol Data Unit (PDU) of Media Access Control (MAC) layer, downlink data transmitted in a Protocol Data Unit (PDU) of Radio Link Control (RLC) layer, downlink data transmitted in a Protocol Data Unit (PDU) of Packet Data Convergence Protocol (PDCP) layer and downlink data transmitted through a downlink control channel.

Detailed description of the method for discontinuous reception according to embodiments of the present invention is made in the above with reference to FIGS. 1-4. Detailed description of the apparatuses for discontinuous reception according to embodiments of the present invention will be made as below with reference to FIGS. 5-8. It should be understood that the apparatus illustrated in FIGS. 5-8 can implement the various steps in FIG. 2, which will not be described in detail to avoid repetition.

FIG. 5 is a block diagram of an apparatus for discontinuous reception according to an embodiment of the present invention. The apparatus can be embodied as or integrated into any of devices which can implement any of embodiments of the method for discontinuous reception as described in the above with reference to FIGS. 1-4. The apparatus 500 illustrated in FIG. 5 comprises: a first receiving unit 510 and a first switching unit 520.

The first receiving unit 510 is configured to receive switch indication information sent by a network device. The switch indication information is used to instruct the terminal to switch from a first discontinuous reception DRX pattern currently being used to a second DRX pattern. The first DRX pattern and the second DRX pattern indicate a duration of a DRX sleeping period and a duration of a DRX active period;

The first switching unit 520 is configured to switch between the DRX sleeping period and the DRX active period with the second DRX pattern.

Optionally, as an embodiment, the apparatus further comprises a second receiving unit configured to receive first indication information sent by the network device. The first indication information indicates the second DRX pattern.

Optionally, as an embodiment, the apparatus further comprises a determining unit configured to determine the second DRX pattern from a DRX pattern set comprising a plurality of different DRX patterns based on the first indication information.

Optionally, as an embodiment, the apparatus further comprises a third receiving unit configured to receive configuration information sent by the network device, wherein the configuration information is used to configure the DRX pattern set for the terminal.

Optionally, as an embodiment, the apparatus further comprises a fourth receiving unit configured to receive second indication information sent by the network device, wherein the second indication information indicates a time period during which the second DRX pattern is used. The first switching unit is further configured to switch between the DRX sleeping period and the DRX active period with the second DRX pattern during the time period.

Optionally, as an embodiment, the apparatus further comprises a second switching unit configured to switch between the DRX sleeping period and the DRX active period with the first DRX pattern after the time period.

Optionally, as an embodiment, the apparatus further comprises a third switching unit configured to switch between the DRX sleeping period and the DRX active period with any one of the following DRX patterns after the time period: the first DRX pattern, a pre-configured DRX pattern and a default DRX pattern under protocols.

Optionally, as an embodiment, the apparatus further comprises: a fifth receiving unit configured to receive third indication information which is sent by the network device and used to instruct the terminal to stop switching between the DRX sleeping period and the DRX active period with the second DRX pattern; a stopping unit configured to stop switching between the DRX sleeping period and the DRX active period with the second DRX pattern.

Optionally, as an embodiment, the apparatus further comprises a fourth switching unit configured to switch between the DRX sleeping period and the DRX active period with any one of the following DRX patterns: the first DRX pattern, a pre-configured DRX pattern and a default DRX pattern under protocols.

Optionally, as an embodiment, the apparatus further comprises a sixth receiving unit configured to receive fourth indication information which is sent by the network device and indicates at least one of the following: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following information: service quality or a service attribute corresponding to downlink data to be transmitted; time required for encoding uplink and/or downlink data; time required for decoding uplink and/or downlink data; transmission time required for transmitting uplink data and/or downlink data.

Optionally, as an embodiment, the service attribute corresponding to downlink data to be transmitted comprises a time interval of transmitting the downlink data to be transmitted, and the service quality corresponding to downlink data to be transmitted comprises a delay requirement of transmitting the downlink data to be transmitted.

Optionally, as an embodiment, the first receiving unit is specifically configured to receive downlink data carrying the switch indication information and sent by the network device.

Optionally, as an embodiment, the downlink data may be any one of the following: downlink data transmitted in a Protocol Data Unit (PDU) of Media Access Control (MAC) layer, downlink data transmitted in a Protocol Data Unit (PDU) of Radio Link Control (RLC) layer, downlink data transmitted in a Protocol Data Unit (PDU) of Packet Data Convergence Protocol (PDCP) layer and downlink data transmitted through a downlink control channel.

FIG. 6 is a block diagram of an apparatus for discontinuous reception according to another embodiment of the present invention. The apparatus can be embodied as or integrated into any of devices which can implement any of embodiments of the method for discontinuous reception as described in the above with reference to FIGS. 1-4. The apparatus 600 illustrated in FIG. 6 comprises: a first sending unit 610 and a second sending unit 620.

The first sending unit 610 is configured to send switch indication information to a terminal, wherein the switch indication information is used to instruct the terminal to switch from a first discontinuous reception DRX pattern currently being used to a second DRX pattern, and wherein the first DRX pattern and the second DRX pattern indicate a duration of a DRX sleeping period and a duration of a DRX active period;

The second sending unit 620 is configured to send downlink data to the terminal when the terminal is in the duration of the DRX active period with the second DRX pattern.

Optionally, as an embodiment, the apparatus further comprises a third sending unit configured to send first indication information indicating the second DRX pattern to the terminal.

Optionally, as an embodiment, the apparatus further comprises a fourth sending unit configured to send second indication information to the terminal, which indicates a time period during which the terminal uses the second DRX pattern.

Optionally, as an embodiment, the apparatus further comprises a fifth sending unit configured to send third indication information to the terminal, which is used to instruct the terminal to stop switching between the DRX sleeping period and the DRX active period with the second DRX pattern.

Optionally, as an embodiment, the apparatus further comprises a sixth sending unit configured to send fourth indication information indicating at least one of the following to the terminal: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following information: service quality or a service attribute corresponding to downlink data to be transmitted; time required for encoding uplink and/or downlink data; time required for decoding uplink and/or downlink data; transmission time required for transmitting uplink data and/or downlink data.

Optionally, as an embodiment, the service attribute corresponding to downlink data to be transmitted comprises a time interval of transmitting the downlink data to be transmitted, and the service quality corresponding to downlink data to be transmitted comprises a delay requirement of transmitting the downlink data to be transmitted.

Optionally, as an embodiment, the first sending unit is specifically configured to send the downlink data carrying the switch indication information to the terminal.

Optionally, as an embodiment, the downlink data may be any one of the following: downlink data transmitted in a Protocol Data Unit (PDU) of Media Access Control (MAC) layer, downlink data transmitted in a Protocol Data Unit (PDU) of Radio Link Control (RLC) layer, downlink data transmitted in a Protocol Data Unit (PDU) of Packet Data Convergence Protocol (PDCP) layer and downlink data transmitted through a downlink control channel.

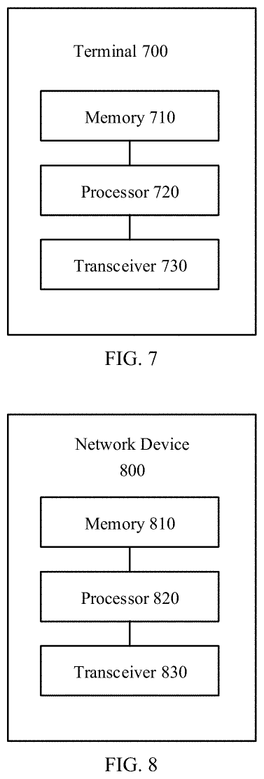

The apparatus as described in the above with reference to FIG. 5 can be embodied as or integrated into for example a terminal which implements any of method embodiments as described with reference to FIGS. 1-4. FIG. 7 is a block diagram of a terminal for discontinuous reception according to an embodiment of the present invention. The terminal 700 illustrated in FIG. 7 comprises a memory 710, a processor 720 and a transceiver 730. The terminal 700 can also include at least one communication bus (not shown in FIG. 7) for implementing connection and communication between these components. The memory 710 is used to store a program, and the processor 720 is configured to perform the program to execute the methods in above various embodiments of the present disclosure. When the program is performed, the transceiver 730 is configured to receive switch indication information which is sent by a network device and used to instruct the terminal to switch from a first discontinuous reception DRX pattern currently being used to a second DRX pattern. The first DRX pattern and the second DRX pattern indicate a duration of a DRX sleeping period and a duration of a DRX active period. The processor 720 is configured to switch between the DRX sleeping period and the DRX active period with the second DRX pattern based on the switch indication information.

Optionally, as an embodiment, the transceiver is configured to receive first indication information which is sent by the network device and indicates the second DRX pattern.

Optionally, as an embodiment, the processor is configured to determine the second DRX pattern from a DRX pattern set comprising a plurality of different DRX patterns based on the first indication information.

Optionally, as an embodiment, the transceiver is configured to receive configuration information sent by the network device, wherein the configuration information is used to configure the DRX pattern set for the terminal.

Optionally, as an embodiment, the transceiver is configured to receive the second indication information sent by the network device, wherein the second indication information indicates a time period during which the second DRX pattern is used. The processor is further configured to switch between the DRX sleeping period and the DRX active period with the second DRX pattern during the time period.

Optionally, as an embodiment, the processor is configured to switch, by the terminal, between the DRX sleeping period and the DRX active period with the first DRX pattern after the time period.

Optionally, as an embodiment, the processor is configured to switch, by the terminal, between the DRX sleeping period and the DRX active period with any one of the following DRX patterns after the time period: the first DRX pattern, a pre-configured DRX pattern and a default DRX pattern under protocols.

Optionally, as an embodiment, the transceiver is configured to receive third indication information which is sent by the network device and used to instruct the terminal to stop switching between the DRX sleeping period and the DRX active period with the second DRX pattern. The processor is further configured to stop switching between the DRX sleeping period and the DRX active period with the second DRX pattern based on the third indication information.

Optionally, as an embodiment, the processor is configured to switch between the DRX sleeping period and the DRX active period with any one of the following DRX patterns: the first DRX pattern, a pre-configured DRX pattern and a default DRX pattern under protocols.

Optionally, as an embodiment, the transceiver is configured to receive fourth indication information which is sent by the network device and indicates at least one of the following: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following information: service quality or a service attribute corresponding to downlink data to be transmitted; time required for encoding uplink and/or downlink data; time required for decoding uplink and/or downlink data; transmission time required for transmitting uplink data and/or downlink data.

Optionally, as an embodiment, the service attribute corresponding to downlink data to be transmitted comprises a time interval of transmitting the downlink data to be transmitted, and the service quality corresponding to downlink data to be transmitted comprises a delay requirement of transmitting the downlink data to be transmitted.

Optionally, as an embodiment, the transceiver is specifically configured to receive downlink data sent by the network device, wherein the downlink data carries the switch indication information.

Optionally, as an embodiment, the downlink data may be any one of the following: downlink data transmitted in a Protocol Data Unit (PDU) of Media Access Control (MAC) layer, downlink data transmitted in a Protocol Data Unit (PDU) of Radio Link Control (RLC) layer, downlink data transmitted in a Protocol Data Unit (PDU) of Packet Data Convergence Protocol (PDCP) layer and downlink data transmitted through a downlink control channel.

The apparatus as described in the above with reference to FIG. 6 can be embodied as or integrated into for example a network device which implements any of method embodiments as described with reference to FIGS. 1-4. FIG. 8 is a block diagram of a network device for discontinuous reception according to an embodiment of the present invention. The network device 800 illustrated in FIG. 8 comprises a memory 810, a processor 820 and a transceiver 830. The network device 800 can also include at least one communication bus (not shown in FIG. 8) for implementing connection and communication between these components. The memory 810 is used to store a program, and the processor 820 is configured to perform the program to execute the methods in above various embodiments of the present disclosure. When the program is performed, the transceiver 830 is configured to send switch indication information to a terminal, wherein the switch indication information is used to instruct the terminal to switch from a first discontinuous reception DRX pattern currently being used to a second DRX pattern, and wherein the first DRX pattern and the second DRX pattern indicate a duration of a DRX sleeping period and a duration of a DRX active period. The transceiver 830 is further configured to send downlink data to the terminal when the terminal is in the duration of the DRX active period with the second DRX pattern.

Optionally, as an embodiment, the transceiver is configured to send first indication information indicating the second DRX pattern to the terminal.

Optionally, as an embodiment, the transceiver is configured to send second indication information to the terminal, which indicates a time period during which the terminal uses the second DRX pattern.

Optionally, as an embodiment, the transceiver is configured to send third indication information to the terminal, wherein the third indication information is used to instruct the terminal to stop switching between the DRX sleeping period and the DRX active period with the second DRX pattern.

Optionally, as an embodiment, the transceiver is configured to send fourth indication information indicating at least one of the following to the terminal: service type information applicable to the second DRX pattern, bearer type information applicable to the second DRX pattern, logical channel information applicable to the second DRX pattern and HARQ process information applicable to the second DRX pattern.

Optionally, as an embodiment, the duration of the DRX sleeping period and/or the duration of the DRX active period are determined based on at least one of the following information: service quality or a service attribute corresponding to downlink data to be transmitted; time required for encoding uplink and/or downlink data; time required for decoding uplink and/or downlink data; transmission time required for transmitting uplink data and/or downlink data.

Optionally, as an embodiment, the service attribute corresponding to downlink data to be transmitted comprises a time interval of transmitting the downlink data to be transmitted, and the service quality corresponding to downlink data to be transmitted comprises a delay requirement of transmitting the downlink data to be transmitted.

Optionally, as an embodiment, the transceiver is specifically configured to send the downlink data carrying the switch indication information to the terminal.

Optionally, as an embodiment, the downlink data may be any one of the following: downlink data transmitted in a Protocol Data Unit (PDU) of Media Access Control (MAC) layer, downlink data transmitted in a Protocol Data Unit (PDU) of Radio Link Control (RLC) layer, downlink data transmitted in a Protocol Data Unit (PDU) of Packet Data Convergence Protocol (PDCP) layer and downlink data transmitted through a downlink control channel.

It should be understood that, in embodiments of the present invention, “B corresponding to A” represents that B is associated with A, and B can be determined based on A. It should also be understood that determining B based on A not only means that B is determined based only on A, but also means that B can be determined based on A and/or other information.

It should be understood that the term “and/or” used herein is merely an association relationship describing associated objects, which indicates that there may three kinds of relationship. For example, “A and/or B” may indicate these three cases: A exists separately, A and B exist simultaneously, and B exists separately. In addition, the character “/” used herein generally indicates that the relationship between the two objects is “or”.

It should be understood that, in various embodiments of the present invention, the sequence numbers of the above processes do not indicate the order of performance. The order of performance of each process should be determined based on its function and internal logic, and should not be taken as any limitation of implementation processes of embodiments of the present invention.

It should be understood that, in several embodiments of the present invention, the disclosed systems, apparatuses and methods may be implemented in other manners. For example, the apparatus embodiments described above are merely illustrative. For example, the division of units is only a division of logical functions, which may be a different division in actual implementations. For example, multiple units or components may be combined or integrated into another system, or some features may be omitted or not be performed. In addition, the couplings or direct couplings or communication connections between each other as shown or discussed may be indirect couplings or communication connections through some interfaces, devices or units, and may also be electrical, mechanical or otherwise.

The units illustrated as separate components may be or may not be physically separated. The components displayed as units may be or may not be physical units, that is, they may be located in one place, or may be distributed on multiple network units. Some or all of the units may be chosen based on actual needs to achieve the purpose of solutions of embodiments.

In addition, individual functional units of each embodiment of the present invention may be integrated into one processing unit, or may exist separately in physics, or two or more units may be integrated into one unit.

The functions may be stored in a computer readable storage medium if implemented in the form of a software function unit and sold or used as an independent product. Based on such an understanding, the technical solution of the present invention which contributes to the state of the art in essence, or part of the technical solution, may be embodied in the form of a software product. This computer software product is stored in a storage medium, including several instructions which are used to cause a computer device (which may be a personal computer, a server or a network device, etc.) to perform all or part of the steps of the method as described in various embodiments of the present invention. The storage medium described above includes various medium in which may store program codes such as a USB flash disk, a mobile hard disk, a ROM (Read-Only Memory), a RAM (Random Access Memory), a diskette, a CD, or the like.

1. A method for discontinuous reception, comprising:
receiving, by a terminal, switch indication information sent by a network device and used to instruct the terminal to switch from a first discontinuous reception DRX pattern being used to a second DRX pattern, wherein each of the first DRX pattern and the second DRX pattern indicates a duration of a DRX sleeping period and a duration of a DRX active period;
switching, by the terminal, between the DRX sleeping period and the DRX active period with the second DRX pattern based on the switch indication information.

2. The method of claim 1, further comprising:
receiving, by the terminal, first indication information sent by the network device and indicating the second DRX pattern.

3. The method of claim 2, further comprising:
determining, by the terminal, the second DRX pattern from a DRX pattern set based on the first indication information, wherein the DRX pattern set includes a plurality of different DRX patterns.

4. The method of claim 3, further comprising:
receiving, by the terminal, configuration information sent by the network device, wherein the configuration information is used to configure the DRX pattern set for the terminal.

5. The method of claim 1, further comprising:
receiving, by the terminal, second indication information sent by the network device and indicating a time period during which the second DRX pattern is used;
wherein switching, by the terminal, between the DRX sleeping period and the DRX active period with the second DRX pattern comprises:
switching, by the terminal, between the DRX sleeping period and the DRX active period with the second DRX pattern during the time period.

6. (canceled)

7. The method of claim 5, further comprising:
switching, by the terminal, between the DRX sleeping period and the DRX active period with any one of following DRX patterns after the time period: the first DRX pattern, a pre-configured DRX pattern and a default DRX pattern under protocols.

8. The method of claim 1, further comprising:
receiving, by the terminal, third indication information sent by the network device and used to instruct the terminal to stop switching between the DRX sleeping period and the DRX active period with the second DRX pattern;
stopping, by the terminal, switching between the DRX sleeping period and the DRX active period with the second DRX pattern based on the third indication information.

9. The method of claim 8, wherein after stopping, by the terminal, switching between the DRX sleeping period and the DRX active period with the second DRX pattern based on the third indication information, the method further comprises:
switching, by the terminal, between the DRX sleeping period and the DRX active period with any one of following DRX patterns: the first DRX pattern, a pre-configured DRX pattern and a default DRX pattern under protocols.

10. (canceled)

11. The method of claim 1, wherein the duration of the DRX sleeping period and/or the duration of the DRX active period are determined based on at least one of the following:
service quality or a service attribute corresponding to downlink data to be transmitted;
time required for encoding uplink and/or downlink data;
time required for decoding uplink and/or downlink data;
transmission time required for transmitting uplink data and/or downlink data.

12. (canceled)

13. The method of claim 1, wherein
receiving, by a terminal, switch indication information sent by a network device comprises:
receiving, by the terminal, downlink data carrying the switch indication information and sent by the network device.

14. (canceled)

15. A method for discontinuous reception, comprising:
sending, by a network device, switch indication information to a terminal, which is used to instruct the terminal to switch from a first discontinuous reception DRX pattern currently being used to a second DRX pattern, wherein the first DRX pattern and the second DRX pattern indicate a duration of a DRX sleeping period and a duration of a DRX active period;
sending, by the network device, downlink data to the terminal when the terminal is in the duration of the DRX active period with the second DRX pattern.

16. The method of claim 15, further comprising:
sending, by the network device, first indication information indicating the second DRX pattern to the terminal.

17. The method of claim 15, further comprising:
sending, by the network device, second indication information, which indicates a time period during which the terminal uses the second DRX pattern, to the terminal.

18. The method of claim 15, further comprising:
sending, by the network device, third indication information to the terminal, which is used to instruct the terminal to stop switching between the DRX sleeping period and the DRX active period with the second DRX pattern.

19.-21. (canceled)

22. The method of claim 1, wherein
sending, by the network device, switch indication information to a terminal comprises:
sending, by the network device, the downlink data carrying the switch indication information to the terminal.

23.-46. (canceled)

47. A terminal, comprising:
a memory;
a processor; and
a transceiver,
wherein the memory is used to store a program code, and the processor is configured to perform the program code, and
wherein, when the program code is performed,
the transceiver is configured to receive switch indication information which is sent by a network device and used to instruct the terminal to switch from a first discontinuous reception DRX pattern currently being used to a second DRX pattern, wherein each of the first DRX pattern and the second DRX pattern indicates a duration of a DRX sleeping period and a duration of a DRX active period;
the processor is configured to switch between the DRX sleeping period and the DRX active period with the second DRX pattern based on the switch indication information.

48. The terminal of claim 16, wherein, when the program code is performed, the transceiver is further configured to receive first indication information sent by the network device and indicating the second DRX pattern.

49. The terminal of claim 16, wherein, when the program code is performed, the transceiver is further configured to receive second indication information sent by the network device and indicating a time period during which the second DRX pattern is used, wherein the processor is further configured to switch between the DRX sleeping period and the DRX active period with the second DRX pattern during the time period.

50. The terminal of claim 18, wherein, when the program code is performed, the processor is further configured to switch between the DRX sleeping period and the DRX active period with any one of following DRX patterns after the time period: the first DRX pattern, a pre-configured DRX pattern and a default DRX pattern under protocols.

51. The terminal of claim 16, wherein, when the program code is performed,
the transceiver is further configured to receive third indication information sent by the network device and used to instruct the terminal to stop switching between the DRX sleeping period and the DRX active period with the second DRX pattern;
the processor is further configured to stop switching between the DRX sleeping period and the DRX active period with the second DRX pattern based on the third indication information.
